(19) United States
(12) Patent Application Publication
(10) Pub. No.: US 2023/0406705 A1
(43) Pub. Date: Dec. 21, 2023

(54) METHOD FOR PRODUCING BORON NITRIDE NANOTUBES

(71) Applicants: PROTERIAL, LTD., Tokyo (JP); NARA INSTITUTE OF SCIENCE AND TECHNOLOGY, Nara (JP)

(72) Inventors: Tadashi Fujieda, Tokyo (JP); Yoshiyuki Nonoguchi, Nara (JP); Florencio Delen De Los Reyes, Nara (JP); Tsuyoshi Kawai, Nara (JP); Akifumi Takeuchi, Tokyo (JP)

(21) Appl. No.: 18/036,973

(22) PCT Filed: Nov. 12, 2021
(86) PCT No.: PCT/JP2021/041701

§ 371 Date: May 15, 2023

(30) Foreign Application Priority Data
Nov. 16, 2020 (JP) 2020-190291

(51) Int. Cl. C01B 21/064

(52) U.S. Cl. CPC C01B 21/0648; C01P 2004/13; C01P 2002/01

(57) ABSTRACT

The purpose of the present invention is to provide a method for producing boron nitride nanotubes, said method reducing the ratio of by-products having less reinforcing effects such as boron nitride fullerenes and boron nitride thin pieces, while enhancing the yield at the same time, without requiring a thermal oxidation treatment. The present invention provides a method for producing boron nitride nanotubes, said method being characterized by comprising: a step for obtaining a suspension by mixing a starting material that contains boron nitride nanotubes, a nonionic polymer dispersant having an sp3-bonded CH group, and an organic solvent; and a step for obtaining a dispersion liquid containing boron nitride nanotubes by subjecting the thus-obtained suspension to centrifugal separation, thereby removing by-products contained in the starting material.

### TECHNICAL FIELD

The present invention relates to a method for producing boron nitride nanotubes.

### BACKGROUND

Boron nitride nanotubes can be obtained by, as described in Japanese Unexamined Patent Application Publication No. 2007-230830 (JP-A-2007-230830), reacting a mixture of magnesium oxide, iron II oxide (FeO), and boron powder with ammonia gas at a temperature between 1100° C. and 1700° C., for example. The obtained boron nitride nanotubes are treated with nitric acid to remove magnesium and iron that are used as catalysts. With such the method, uniform boron nitride nanotubes having diameters between 20 nm and 50 nm can be obtained. The obtained boron nitride nanotubes are then added to an organic solvent solution in which poly [m-phenylenevinylene-co-(2,5-dioctoxy-p-phenylenevinylene)], which is a high polymer, is dissolved in an organic solvent such as chloroform. JP-A-2007-230830 discloses that the boron nitride nanotubes are coated by the above polymer, i.e., polymer-wrapped, so as to obtain a uniform and transparent dispersion liquid of boron nitride nanotubes. JP-A-2007-230830 also discloses a refining method in which the uniform transparent dispersion liquid is produced by removing impurities by a two-hour ultrasonic treatment at a room temperature and a centrifugal separation, evaporating the organic solvent from the dispersion liquid, and further eliminating PmPV by pyrolysis so as to obtain boron nitride nanotubes with uniform diameters. In the descriptions below, poly [m-phenylenevinylene-co-(2,5-dioctoxy-p-phenylenevinylene)] will be shortened as PmPV.

In recent years, as shown in Published Japanese Translation of PCT International Publication for Patent Application No. 2016-521240 (JP-T-2016-521240), it has been possible to very efficiently produce moderately pure and thin (having diameters of 10 nm or less) boron nitride nanotubes (hereinafter, shortened as BNNTs) continuously and at high yield at or near the atmospheric pressure without a need for using metals as catalysts. To be specific, JP-T-2016-521240 discloses a method for producing BNNTs, where the method includes a step of providing one or more sources of each of boron, nitrogen, and hydrogen into a stable induction plasma at a plasma temperature in a range between 1,000 K and 10,000 K to form a reaction mixture of boron, nitrogen, and hydrogen in a plasma at a pressure more than 0.6 atm and less than 2 atm, and a step of cooling the reaction mixture to form BNNTs, in which the one or more boron sources include a boron element, boron nitride, borane, ammonia borane, borazine, or a mixture of any of the above.

International Patent Publication No. 2020/031883 (WO 2020/031883) discloses a material using such the boron nitride nanotubes. Such the material includes boron nitride nanotubes and hollow particles of boron nitride fullerenes, in which the hollow particles of boron nitride fullerenes are dispersed between the boron nitride nanotubes, the hollow particles of boron nitride fullerenes existing among and being in contact with the boron nitride nanotubes. WO 2020/031883 also discloses a method in which boron in boron nitride nanotubes obtained by the method disclosed in JP-T-2016-521240, for example, is converted into boron oxide (B₂O₃) by a thermal oxidation treatment and the boron oxide is then cleansed and removed by a solvent such as ethanol, methanol, or water, in which the boron oxide can dissolve.

It has been a problem that the products synthesized by the producing methods disclosed in JP-A-2007-230830 and JP-T-2016-521240 include a high proportion of by-products such as boron nitride fullerene and boron nitride thin pieces, which have smaller aspect ratio than boron nitride nanotubes with less reinforcing effects when combined with metals or ceramics. The by-products such as boron nitride fullerene and boron nitride thin pieces have similar crystal structures as boron nitride nanotubes and are easily formed in the synthesis process. Thus, JP-A-2007-230830 discloses a refining method for reducing the proportion of such the by-products. However, this raises another problem of low yielding of boron nitride nanotubes. Furthermore, there is yet another problem of low dispersibility of boron nitride nanotubes due to adhesion between the boron nitride nanotubes and the by-products through the thermal oxidation treatment described in JP-T-2016-521240 and WO 2020/031883.

### SUMMARY OF THE DISCLOSURE

It is an object of the present invention to provide a method for producing boron nitride nanotubes, wherein the method can reduce a proportion of by-products, such as boron nitride fullerenes and boron nitride thin pieces, that have less reinforcing effects and at the same time can improve yield without even a need of a thermal oxidation treatment.

The present invention is a method for producing boron nitride nanotubes. The method includes obtaining a suspension by mixing a starting material that includes boron nitride nanotubes, a nonionic polymer dispersant having an sp3-bonded CH group, and an organic solvent, and obtaining a dispersion liquid including the boron nitride nanotubes by performing centrifugal separation on the obtained suspension to remove by-products contained in the starting material.

It is preferable that the polymer dispersant includes a cellulose polymer or a vinyl polymer.

The present invention can provide a method for producing boron nitride nanotubes, wherein the method can reduce a proportion of by-products that have less reinforcing effects, such as boron nitride fullerenes and boron nitride thin pieces, and at the same time can improve yield without even a need of a thermal oxidation treatment.

### BRIEF DESCRIPTION OF DRAWINGS

FIG. 1 is a low magnification TEM image of collected BNNT products.

FIG. 2 is a low magnification TEM image of a sample of a BNNT dispersion liquid of Working Example 1 from which a solvent is removed.

FIG. 3 is a high-resolution TEM image of the sample of the BNNT dispersion liquid of Working Example 1 from which the solvent is removed.

FIG. 4 is a high-resolution TEM image of a sample of the BNNT dispersion liquid of Working Example 1, which has been dried and then heated at a temperature of 500° C. for one hour in the atmosphere.

FIG. 5 is a low magnification TEM image of a sample of a BNNT dispersion liquid of Working Example 2 from which a solvent is removed.

FIG. 6 is a low magnification TEM image of a sample of a BNNT dispersion liquid of Comparison Example 1 from which a solvent is removed.

FIG. 7 is a low magnification TEM image of a sample of a BNNT dispersion liquid of Comparison Example 2 from which a solvent is removed.

### DETAILED DESCRIPTION

Hereinafter, a method for producing boron nitride nanotubes according to an embodiment of the present invention will be described with reference to the accompanying drawings. In the descriptions below, boron nitride nanotubes may be shortened as BNNTs.

First, a step of obtaining a suspension by mixing a starting material that includes a product after synthesis from which water is removed, i.e., boron nitride nanotubes, a nonionic polymer dispersant having an sp3-bonded CH group, and an organic solvent. In this step, it is preferable that the nonionic polymer dispersant having an sp3-bonded CH group is dissolved in the organic solvent in advance to make a homogeneous solution so as to coat the boron nitride nanotubes uniformly with the polymer dispersant. The product after synthesis is then added to the solution, and, by ultrasonic dispersion using a homogenizer or the like, the polymer dispersant coats the boron nitride nanotubes uniformly. To prevent an increase in temperature of the liquid during the ultrasonic dispersion, it is preferable that the solution is cooled throughout the process.

In the present invention, “the product after synthesis” refers to not only the products in a state immediately after synthesis but also refers to those treated with other processes after synthesis of BNNTs and before the step according to the present invention. That is, the starting material including boron nitride nanotubes refers not only to the products that are intact after synthesis, but also refers to the boron nitride nanotubes from which by-products contained in the products that are intact after synthesis are removed to a certain extent by other treatments. Thus, in descriptions hereafter, “the product after synthesis” refers to all the materials that include boron nitride nanotubes that are used in producing processes for BNNT according to the present invention that will be described below.

As the nonionic polymer dispersant having an sp3-bonded CH group, it is preferable to use a cellulosic polymer, such as ethyl cellulose, methyl cellulose, propyl cellulose, butyl cellulose, hydroxyl propyl cellulose, and acetyl cellulose, which is a high polymer in which at least one of replaceable hydroxyl groups at 2-position, 3-position, and 6-position has a substituted glucose structure, i.e., alkyl ether, as a repeating unit and the hydroxyl groups at 1 and 4 positions are combined, or a vinyl polymer, such as poly vinyl butyral, poly vinyl formal, poly vinyl acetate, ethylene-vinyl acetate polymer, polystyrene, poly vinyl alcohol, poly acrylonitrile, poly vinyl methyl ketone, and poly methyl methacrylate, which is a high polymer having at least one or more methylene groups and at least one or more substituted methylene groups as repeating units. This is because, since symmetry of π orbital of the boron nitride nanotubes is low, a polymer that interacts with boron nitride nanotubes in CH/π can be more easily combined with boron nitride nanotubes than a polymer that interacts with boron nitride nanotubes in π/π, such as the polymer used in JP-A-2007-230830. Also, the main chain of the nonionic polymer having an sp3-bonded CH group is more flexible than the main chain of an sp2-bonding of a polymer used in JP-A-2007-230830, and is easier to be wrapped around the boron nitride nanotube having a thin diameter. For this reason, particularly for the boron nitride nanotubes having thin diameters obtained in JP-T-2016-521240 or WO 2020/031883, it is considered that using the nonionic polymer dispersant having an sp3-bonded CH group is easier in coating.

Carboxymethyl cellulose (CMC) used widely as a polymer dispersant for carbon nanotubes (CNT) is an ionic polymer having an sp3-bonded CH group, in which an aqueous solvent is used. If such the CMC is applied as a dispersant for thin BNNTs, micelles are formed around the BNNTs and the BNNTs are contained in a hydrophobic space formed by the micelles, which solubilizes the BNNTs. However, since sizes of the micelles follow shapes of substances and the micelles solubilize substances regardless of their shapes, by-products other than the BNNTs are also solubilized. Thus, it is considered that it is difficult for CMC to selectively solubilize only the BNNTs having small diameters. On the other hand, in the case of the nonionic polymer having an sp3-bonded CH group, the organic solvent is used and thus micelles are not formed around the BNNTs. Accordingly, the difference between the shapes and sizes of the BNNTs and impurities (the by-products other than the BNNTs) results in a difference in adsorption properties of dispersant to the BNNTs and the impurities, respectively, as well as solubilization properties of the BNNTs and the impurities. This makes it easier to separate the BNNTs from the impurities, and thus the BNNTs can be dispersed selectively.

As the organic solvent, benzyl alcohol, methanol, ethanol, isopropyl alcohol, butanol, acetone, methyl ethyl ketone, diethyl ketone, methyl isobutyl ketone, ethyl acetate, butyl acetate, N-methyl pyrrolidon, N,N-dimethyl form amide, cyclohexanone, isophorone, tetrahydrofuran, 2-methyltetrahydrofuran, ethyl lactate, butyl lactate, ethylene glycol dimethyl ether, or the like may be used.

After mixing the starting material, the dispersant, and the organic solvent, the mixture may be stirred by using an ultrasonic homogenizer, for example. The mixture is stirred under predetermined stirring conditions, followed by a separation process, which will be described below, and then SEM images or the like of a supernatant liquid and residues are checked to determine conditions for stirring according to separation performance of the by-products and fracture prevention effects of the BNNTs. For example, after stirring under a plurality of conditions and checking the respective images after separation, conditions under which an amount of the by-products found in the supernatant liquid is relatively small and fractures and breakage of the BNNTs are unnoticeable, or conditions under which an amount of fractured BNNTs in the residue is unnoticeable may be used. For example, a frequency of 20 kHz, an ultrasonic wave amplitude between 40 μm and 80 μm, and a stirring time approximately between 20 minutes and 40 minutes are preferable since the boron nitride nanotubes are not easily fractured and can be easily dispersed under such conditions. The suspension can be obtained through the above operations.

The composition of the product after synthesis, that is the suspension liquid obtained by mixing the starting material including the boron nitride nanotubes, the nonionic polymer dispersant having an sp3-bonded CH group, and the organic solvent, may be 1 pts.mass of the starting material including the boron nitride nanotubes, 1-2000 pts.mass of the nonionic polymer dispersant having an sp3-bonded CH group, and 200-100000 pts.mass of the organic solvent. A lower limit of an amount of added dispersant is determined, for example, according to separation performance of the by-products after performing the separation process described below and checking the SEM images or the like of the supernatant liquid and the residues. For example, the amount of added dispersant is varied under a plurality of conditions, and from the respective images after separation, conditions under which the amount of the BNNTs found in the supernatant liquid is relatively large and the BNNTs are not bundled, or conditions under which an amount of BNNTs within the residue is unnoticeable may be used. Also, by checking an optical absorption characteristic in the ultraviolet region of the dispersion liquid after the separation process described below and by using a relationship between the maximum absorption amount and the amount added, an upper limit of the amount of added dispersant is determined from a condition at which an increase in an amount of the optical absorption due to an increase in the amount added is approximately saturated, for example. This range of the dispersant and solvent is preferable because it is economical without waste at or under the upper limit, and the dispersibility of BNNTs is better at or above the lower limit. To confirm whether there is bundling of the BNNTs or not, the SEM images or the like are checked and it can be confirmed that several to several tens of BNNTs are bundled during the dispersion if the dispersed BNNTs are thicker than the BNNTs in the starting material, for example.

Next, a centrifugal separation process of the obtained suspension will be described. This operation removes the by-products. Here, the by-products refer to BN fullerenes and h-BN thin pieces etc. contained in the above solution having boron particles as a core. The conditions for separating such the by-products by centrifugal separation are determined according to separation performance of the by-products after performing the separation process and checking the SEM images or the like of a supernatant liquid and residue. For example, a plurality of conditions (time and centrifugal force) are varied, and from the respective images after separation, conditions under which the amount of the by-products found in the supernatant liquid is relatively small and an amount of the dispersant polymer (the film-like substance coating the by-products as a whole) within the residue is large may be used. For example, a centrifugal acceleration may be 30,000 G or more, a processing time may be one hour or more, and a liquid temperature may be 25° C.

Finally, a process for removing the by-products contained in the starting material by centrifugal separation of the obtained suspension to obtain a dispersion liquid including the boron nitride nanotubes will be described. The by-products can be removed from the suspension by using a high-speed refrigerated centrifuge, for example. By removing the by-products contained in the starting material, a BNNT dispersion liquid in which BNNTs that are coated by the nonionic polymer having an sp3-bonded CH group are dispersed in the organic solvent can be obtained.

Furthermore, a method for obtaining BNNTs from the BNNT dispersion liquid will be described. First, the organic solvent is evaporated from the above-mentioned BNNT dispersion liquid. With this step, BNNT is coated by a solid polymer dispersant. Next, the BNNTs coated by the above-mentioned dispersant is heated in an atmosphere at a temperature between 300° C. and 900° C. so as to remove the dispersant by pyrolysis. This can refine the BNNTs contained in the dispersion liquid to be highly refined. The heating temperature of 300° C. or higher is preferable since the dispersant can be thermally decomposed easily at the heating temperature of 300° C. or higher. On the other hand, the temperature of 900° C. or lower is preferable since the BNNTs can remain without being burned out at the temperature of 900° C. or lower. Furthermore, the temperature below 650° C. is preferable since the temperature below 650° C. is lower than a temperature of thermal oxidation process of the boron particles and this can prevent adhesion between the boron nitride nanotubes and the by-products, which makes it easier for the boron nitride nanotubes to be dispersed.

### Working Example 1

Next, working examples will be described.

First, a boron nitride nanotube dispersion liquid to be evaluated is prepared by the following method. Firstly, a small plasma device (TekNano-15 by TEKNA Plasma Systems Inc.) is used in the following manner to synthesize BNNT products including by-products, i.e., a starting material including boron nitride nanotubes. Initially, a reaction vessel is purged with argon gas. Next, argon gas flows into a central region (flow rate: 10 L/min), and sheath gas flows on an outer circumference of a tube confining plasma by flowing a mixed gas of argon (30 L/min) and hydrogen (2.5 L/min). Nitrogen gas flows through both a torch nozzle (10 L/min) and a porous wall (47 L/min) surrounding the reaction vessel. A few minutes after plasma ignition, when a temperature of a thermocouple provided between the reaction vessel and a cyclone becomes constant, h-BN powder (average particle diameter: 5 μm), which is the raw material, is continuously supplied from a feeder installed at an upper part of the plasma torch with argon (2.5 L/min) as carrier gas. The feed rate is 0.5 g/min, the operation time is two hours, and the pressure inside the reaction chamber is 1 atm. After completion of the synthesis, the device is disassembled and products adhering to the plasma torch, reactor, cyclone, and filter sections are collected.

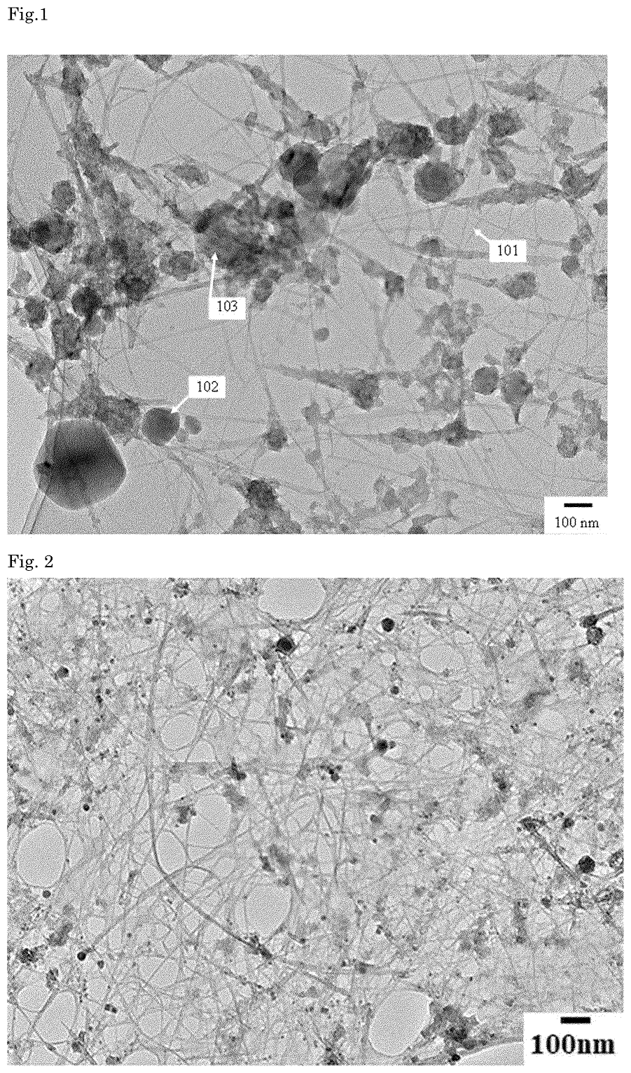

The collected products after synthesis are observed under a microscope. FIG. 1 is a low magnification image under a transmission electron microscope (TEM) of the obtained products. The products include a BNNT 101, a BN fullerene 102, and an h-BN thin piece 103. The BN fullerene 102 is a substance having a grapheme structure in which B atoms and N atoms are alternately coupled and having a closed spherical or long spherical structure. Also, the h-BN thin piece 103 is a sheet-shaped substance formed of crystalline h-BN. Boron particles (black contrasting areas) are incorporated into the BN fullerene 102. Other synthesizing method may also be used to synthesize the products.

Next, the products after synthesis are used and treated by the following method as Working Example 1. 25 mg of ethyl cellulose (EC) manufactured by Tokyo Chemical Industry Co., Ltd. as the dispersant is mixed with 20 cm 3 of benzyl alcohol as the organic solvent, and the mg of the products synthesized as above is added to the solution. That is, to 1 pts.mass of the products after synthesis, i.e., the starting material including boron nitride nanotubes, 1.7 pts.mass of the nonionic polymer dispersant having an sp3-bonded CH group and 1333 pts.mass of the organic solvent are used. The mixture is then dispersed by an ultrasonic homogenizer at a room temperature for twenty minutes. This is followed by centrifugal separation with a centrifugal acceleration of 30,000 G for three hours to remove the by-products contained in the starting material and to obtain a BNNT dispersion liquid.

FIG. 2 is a low magnification TEM image of a sample of the BNNT dispersion liquid from which the solvent is removed. It is found that BN fullerene and h-BN thin pieces contained in the post-products after synthesis shown in FIG. 1 are removed. This shows that a proportion of the by-products such as BN fullerene and h-BN thin pieces having small strengthening effects is reduced.

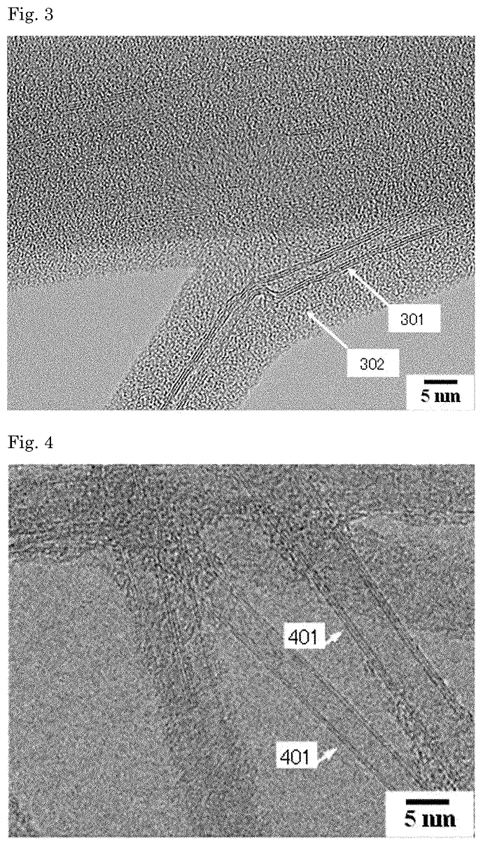

FIG. 3 is a high-resolution TEM image of the sample in FIG. 2. A surface of a BNNT 301 is coated with an amorphous substance 302, which is considered to be ethyl cellulose.

Next, to thermally decompose and remove the ethyl cellulose adhering to the surface of the BNNTs, the BNNT dispersion liquid is dried and heated for one hour at a temperature of 500° C. in the atmosphere. Although a step of oxidation in the atmosphere at a temperature within a range between 650° C. and 800° C. is required as a thermal oxidation treatment in JP-T-2016-521240, such the process is not performed in Working Example 1.

FIG. 4 is a high-resolution TEM image of a sample prepared by adding the BNNTs that have been heat treated in the atmosphere to isopropyl alcohol and dropping the sonicated BNNT dispersion liquid onto a copper grid coated with a carbon film. It is observed that the amorphous layer on the BNNT surface has disappeared, and, with sidewalls of BNNT 401 being clearly observed, it is confirmed that the BNNTs are in perfect crystallized states.

### Working Example 2

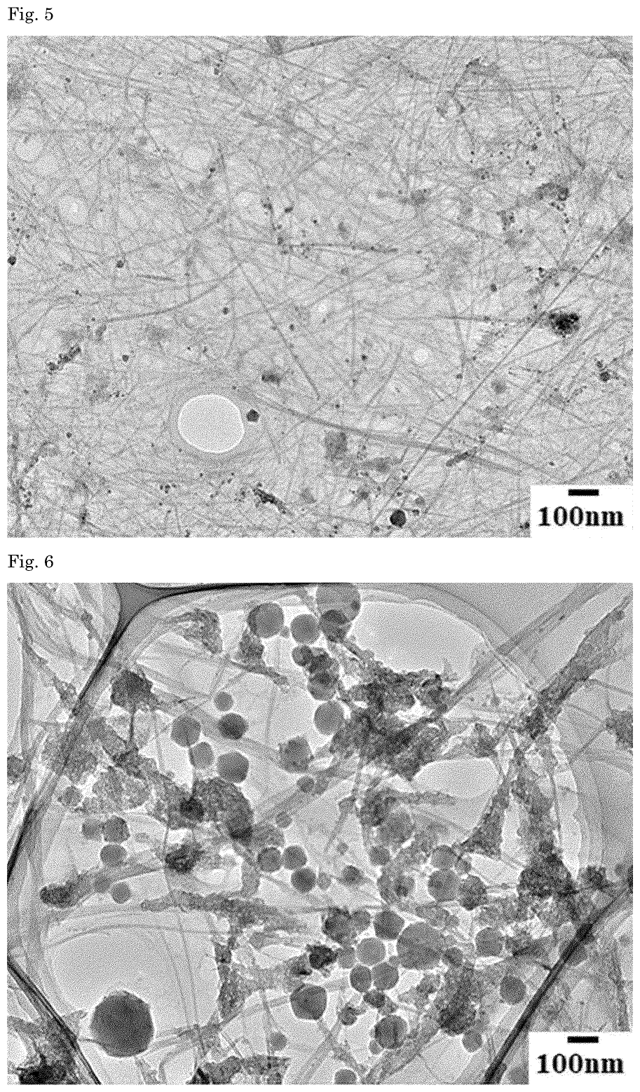

For Working Example 2, BNNTs are obtained similarly as in Working Example 1 except that poly vinyl butyral (PVB), which is a vinyl polymer, is used as the dispersant. FIG. 5 is a low magnification TEM image of a sample of the BNNT dispersion liquid from which the solvent is removed. Similarly to Working Example 1, it is confirmed that the proportion of the by-products such as BN fullerene and h-BN thin pieces having small strengthening effects is reduced.

### Comparison Example 1

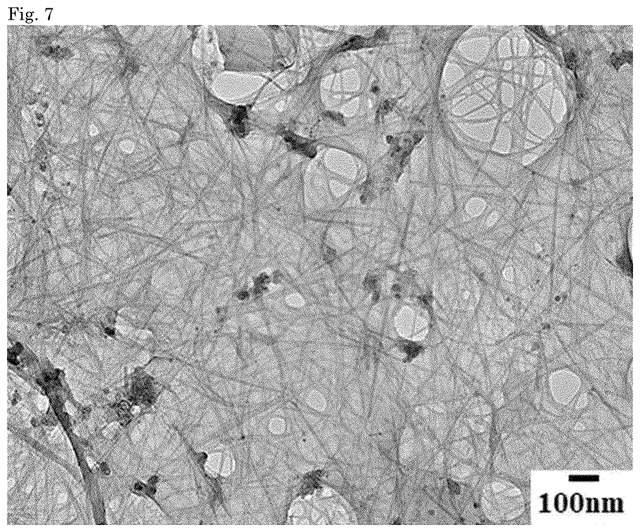

For Comparison Example 1, BNNTs are obtained similarly as in Working Example 1 except that poly [m-phenylenevinylene-co-(2,5-dioctoxy-p-phenylenevinylene)] (PmPV), which is a nonionic polymer having an sp2-bonded CH group, is used as the dispersant. FIG. 6 is a low magnification TEM image of a sample of the BNNT dispersion liquid from which the solvent is removed. It is confirmed that the proportion of the by-products such as BN fullerene and h-BN thin pieces having small strengthening effects is reduced.

### Comparison Example 2

For Comparison Example 2, BNNTs are obtained similarly as in Working Example 1 except that carboxymethyl cellulose (CMC), which is an ionic polymer having an sp3-bonded CH group, is used as the dispersant and water is used as the solvent. FIG. 7 is a low magnification TEM image of a sample of the BNNT dispersion liquid from which the solvent is removed. It is confirmed that there are many of the by-products such as BN fullerene and h-BN thin pieces having small strengthening effects being remained.

Among Working Examples 1 and 2 and Comparison Examples 1 and 2, from the TEM images of the samples of the BNNT dispersion liquid from which the solvent is removed, Working Example 2 has the smallest amount of the residual by-products (such as BN fullerene and h-BN thin pieces) on the whole, followed by Working Example 1 and Comparison Example 1, and Comparison Example 2 is found to have the largest amount of the residual by-products. This is because the ionic polymer is used as the dispersant and water is used as the solvent in Comparison Example 2, which, as mentioned above, resulted in formation of micelles around the BNNTs and solubilization of relatively coarse by-products (such as BN fullerene and h-BN thin pieces) similarly as the BNNTs, thereby deteriorating the selective dispersibility of the BNNTs.

Also, a yield of the dispersed BNNTs is calculated by using the following formula for each of Working Examples 1 and 2 and Comparison Examples 1 and 2.

Yield (%)={(“Mass of products after synthesis”−“Mass of residue after centrifugal separation”)/“Mass of products after synthesis”}×100

The result shows that the yields are, in a descending order: Working Example 1 (55%)>Working Example 2 (51%)>Comparison Example 1 (32%)>Comparison Example 2 (20%).

The dispersion liquid in Comparison Example 1 has an sp-2 bonded main chain and thus is more rigid than EC or PVB having an sp-3 bonded main chain, which makes it particularly difficult for the dispersion liquid to be wrapped around BNNTs having small diameters, and this may have deteriorated the dispersibility.

The above results show that, compared to the case in which the dispersant in the comparison examples is used, when the dispersant of the present invention is used, the residual amount of the by-products is smaller (with higher purity of BNNTs) and the yields of the BNNTs are higher.

The technical scope of the present invention is not limited to the embodiments described above. It is obvious that persons skilled in the art can think out various examples of changes or modifications within the scope of the technical idea disclosed in the claims, and it will be understood that they naturally belong to the technical scope of the present invention. For example, the conditions for the ultrasonic treatment or the centrifugal separation used in the production of the dispersion liquid may be selected appropriately according to the mixing mass ratio of the BNNTs, the dispersant, and the solvent.

What is claimed is:

1. A method for producing boron nitride nanotubes, the method comprising:
obtaining a suspension by mixing a starting material that includes boron nitride nanotubes, a nonionic polymer dispersant having an sp3-bonded CH group, and an organic solvent; and
obtaining a dispersion liquid including the boron nitride nanotubes by performing centrifugal separation on the obtained suspension to remove by-products contained in the starting material.

2. The method for producing boron nitride nanotubes according to claim 1, wherein the polymer dispersant includes a cellulose polymer or a vinyl polymer.
